(19) United States
(12) Patent Application Publication
(10) Pub. No.: US 2025/0015728 A1
(43) Pub. Date: Jan. 9, 2025

(54) FLYBACK CONVERTER AND SWITCH CONTROL CIRCUIT, CONTROL METHOD THEREOF

(71) Applicant: Joulwatt Technology Co., Ltd., Hangzhou (CN)

(72) Inventors: Xianghua JIANG, Hangzhou (CN); Pitleong WONG, Hangzhou (CN); Xiangyong XU, Hangzhou (CN); Junming ZHANG, Hangzhou (CN)

(21) Appl. No.: 18/761,370

(22) Filed: Jul. 2, 2024

(30) Foreign Application Priority Data
Jul. 3, 2023 (CN) 202310816487.X

(51) Int. Cl. H02M 3/335; H02M 1/00; H02M 1/08; H02M 3/00

(52) U.S. Cl. CPC H02M 3/33592; H02M 1/0054; H02M 1/08; H02M 3/01

(57) ABSTRACT

Disclosed is a flyback converter, a switch control circuit and a control method thereof. A driving current regulation circuit generates a current regulation trigger signal at active state correspondingly according to an operating state of the flyback converter. A switch control driving unit regulates a driving current of the first switch transistor according to the current regulation trigger signal at active state, thus a variation rate of a drain-source voltage across the first switch transistor is slowed down to a preset range. According to the present disclosure, when it is detected that the flyback converter is operating in discontinuous conduction mode or the drain-source voltage across the first switch transistor is high, a switching rate of the first switch transistor is controlled to avoid the voltage across a rectifier switch transistor on a secondary side of the flyback converter to undergo a large jump, and the system EMI is good.

### CROSS-REFERENCE TO RELATED APPLICATION

This application claims priority to Chinese patent application No. 202310816487.X, filed on Jul. 3, 2023, and entitled “FLYBACK CONVERTER AND SWITCH CONTROL CIRCUIT, CONTROL METHOD THEREOF”, published as CN117277755A on Dec. 22, 2023, the entire contents of which are incorporated by reference.

### FIELD OF THE DISCLOSURE

The present disclosure relates to a technical field of power electronics, and more particularly, to a flyback converter, a switch control circuit of a flyback converter, and a control method of a flyback converter.

### DESCRIPTION OF THE RELATED ART

Flyback converters are widely used in electronic devices that are required to have good isolation performance, and through a transformer, a flyback converter can transmit energy from the primary side to the secondary side of the transformer which performs isolation. In some applications, a flyback converter may have an asymmetric half-bridge topology, or an active clamp half-bridge topology.

In a flyback converter with an asymmetric half-bridge topology, the flyback converter includes a main switch transistor and an auxiliary switch transistor connected between an input terminal and a reference ground, and a resonant circuit can be formed by a primary side winding of a transformer, the auxiliary switch transistor, a first inductor and a first capacitor. In a flyback converter with an active clamping circuit, the flyback converter not only includes a main switch transistor connected between a primary side winding of a transformer and a reference ground, but also includes an auxiliary switch transistor and a first capacitor both connected between an input voltage terminal and the primary side winding, and a resonant circuit can be formed by the primary side winding of the transformer, the auxiliary switch transistor, a first inductor and the first capacitor, wherein the first inductor of the flyback converter with the active clamping circuit and the first inductor of the flyback converter with the asymmetric half-bridge topology can both be a leakage inductor of the transformer.

On the secondary side of the transformer, the secondary side winding of the transformer and a rectifier switch transistor on the secondary side are connected in series between a voltage output terminal and the reference ground on the secondary side. An output capacitor is connected between the voltage output terminal and the reference ground on the secondary side, and is configured to filter a DC output voltage to obtain a smooth voltage.

In the prior art, under discontinuous conduction mode (DCM mode), the auxiliary switch transistor can be turned on once before the main power transistor is turned on, so that the main switch transistor can realize zero-voltage switching. However, a pulse for additionally turning on the auxiliary switch transistor may cause the auxiliary switch transistor to be hard turned on, and may also increase a stress of the rectifier switch transistor on the secondary side, which will increase turn-on loss of the entire system, and may cause EMI problems.

Therefore, it is necessary to provide an improved technical solution to overcome the above technical problems in the prior art.

### SUMMARY OF THE DISCLOSURE

In view of this, an objective of the present disclosure is to provide a flyback converter, a switch control circuit of a flyback converter, and a control method of a flyback converter, to solve turn-on loss problems and EMI technical problems of the flyback converter system existing in the prior art.

The present disclosure provides a switch control circuit of a flyback converter comprising a transformer, a first switch transistor, a second switch transistor, a first capacitor and a first inductor, wherein a resonant circuit is formed by the first capacitor and the first inductor when the second switch transistor is in turn-on state, and the switch control circuit comprises: a switch control driving unit, configured to generate a first switch driving signal and a second switch driving signal according to an output feedback signal of the flyback converter, to drive the first switch transistor and the second switch transistor, respectively; a driving current regulation circuit, configured to generate a current regulation trigger signal according to an operating state of the flyback converter, wherein the current regulation trigger signal is transmitted to the switch control driving unit, and when the current regulation trigger signal is at inactive state, the switch control driving unit is configured to drive the first switch transistor to be turned on at a first switching rate; when the current regulation trigger signal is at active state, the switch control driving unit is configured to drive the first switch transistor to be turned on at a second switching rate, which is lower than the first switching rate.

Optionally, when the first switch transistor is turned on at the second switching rate, a variation rate of a drain-source voltage across the first switch transistor is slowed down to a preset range.

Optionally, depending on a type of the first switch transistor, the preset range is set as follows: when the first switch transistor is a silicon-based transistor, the preset range is set to 2V/ns to 20V/ns; when the first switch transistor is a GaN-based transistor, the preset range is set to 5V/ns to 200V/ns.

Optionally, when the current regulation trigger signal is at active state, the switch control driving unit is configured to control a pull-up driving current of the first switch transistor to decrease, so as to drive the first switch transistor to be turned on at the second switching rate.

Optionally, the driving current regulation circuit comprises a voltage detection circuit and a comparison circuit, the voltage detection circuit is configured to obtain a voltage detection signal by detecting the drain-source voltage across the first switch transistor before the first switch transistor is turned on, the comparison circuit is configured to compare the voltage detection signal and a first threshold voltage, and generate the current regulation trigger signal at active state when the voltage detection signal is greater than the first threshold voltage.

Optionally, the driving current regulation circuit comprises a mode detection circuit, configured to generate the current regulation trigger signal at active state when the mode detection circuit detects that the flyback converter is operating in discontinuous conduction mode.

Optionally, the driving current regulation circuit is configured to detect an operation mode of the flyback converter according to switching times of the first switch transistor and the second switch transistor, and the mode detection circuit detects that the flyback converter is operating in discontinuous conduction mode when a time interval, which starts from a time for turning off the second switch transistor to a time for turning on the first switch transistor, reaches a first time threshold.

Optionally, the driving current regulation circuit is configured to detect an operation mode of the flyback converter according to an output reference signal and the output feedback signal of the flyback converter.

Optionally, the switch control driving unit comprises a switch control signal generation circuit and a driving unit,
the switch control signal generation circuit is configured to generate a first switch control signal and a second switch control signal according to the output feedback signal and the output reference signal, and the driving unit is configured to generate the first switch driving signal and the second switch driving signal according to the first switch control signal and the second switch control signal, respectively.

Optionally, the driving unit comprises a plurality of driving switches connected in parallel, and the switch control driving unit is configured to adjust a number of one or more of the plurality of driving switches that is turned on according to the current regulation trigger signal at active state, so as to regulate a pull-up driving current of the first switch transistor.

Optionally, the driving unit comprises a plurality of parallel driving branches, each of which is formed by a current source and a resistor, and the switch control driving unit is configured to regulate a current flowing through one or more of the plurality of parallel driving branches according to the current regulation trigger signal at active state, so as to control a pull-up driving current of the first switch transistor.

Optionally, the switch control signal generation circuit comprises a signal generation circuit and a signal regulation circuit, and the signal generation circuit is configured to generate the first switch control signal and the second switch control signal according to the output feedback signal and the output reference signal; the signal regulation circuit is configured to perform regulation on the first switch control signal and the second switch control signal according to the current regulation trigger signal, so as to transmit the first switch control signal and the second switch control signal which are obtained after the regulation, to the driving unit as output signals.

Optionally, the driving unit comprises a logic operation circuit and a driving circuit, the logic operation circuit generates a first logic operation signal and a second logic operation signal according to the current regulation trigger signal, the first switch control signal and the second switch control signal, and the driving circuit that controls a pull-up driving current of the first switch transistor and a pull-up driving current of the second switch transistor according to the first logic operation signal and the second logic operation signal.

The present disclosure provides a switch control method of a flyback converter, which includes a transformer, a first switch transistor, a second switch transistor, a first capacitor and a first inductor, wherein a resonant circuit is formed by the first capacitor and the first inductor when the second switch transistor is in turn-on state, and the switch control method comprises: generating a current regulation trigger signal at active state correspondingly according to an operating state of the flyback converter, generating a first switch driving signal and a second switch driving signal according to an output feedback signal of the flyback converter to drive the first switch transistor and the second switch transistor, respectively, and controlling the first switch transistor to be turned on at a first switching rate when the current regulation trigger signal is at inactive state;
when the current regulation trigger signal is at active state, controlling the first switch transistor to be turned on at a second switching rate, wherein the second switching rate is lower than the first switching rate.

Optionally, when the current regulation trigger signal is at active state, a pull-up driving current of the first switch transistor is regulated to decrease, to control the first switch transistor to be turned on at the second switching rate.

Optionally, when the first switch transistor is turned on at the second switching rate, a variation rate of a drain-source voltage across the first switch transistor is slowed down to a preset range.

Optionally, depending on a type of the first switch transistor, the preset range is set as follows:
when the first switch transistor is a silicon-based transistor, the preset range is set to 2V/ns to 20V/ns;
when the first switch transistor is a GaN-based transistor, the preset range is set to 5V/ns to 200V/ns.

Optionally, generating the current regulation trigger signal at active state correspondingly according to the operating state of the flyback converter comprises: when the flyback converter is operating in discontinuous conduction mode, generating the current regulation trigger signal at active state correspondingly.

Optionally, generating the current regulation trigger signal at active state correspondingly according to the operating state of the flyback converter comprises: before the first switch transistor is turned on, when the drain-source voltage across the first switch transistor of the flyback converter is greater than a first threshold voltage, generating the current regulation trigger signal at active state correspondingly.

Optionally, when the drain-source voltage across the first switch transistor of the flyback converter decreases to be lower than a second threshold voltage, the first switch transistor is controlled to be turned on at the first switching rate, and when the drain-source voltage across the first switch transistor of the flyback converter rises to be greater than the first threshold voltage, the first switch transistor is controlled to be turned on at the second switching rate, wherein the first threshold voltage is greater than the second threshold voltage.

The present disclosure also provides a flyback converter including a transformer, a first switch transistor and a second switch transistor, a first capacitor, a first inductor, and the switch control circuit as described above, wherein a resonant circuit is formed by the first capacitor and the first inductor when the second switch transistor is in turn-on state, and the switch control circuit is configured to control the first switch transistor and the second switch transistor to be turned on and off; the flyback converter further includes a rectifier switch transistor, wherein the first switch transistor and the second switch transistor are located on a primary side of the transformer, and the rectifier switch transistor is located on a secondary side of the transformer.

By using a solution for controlling a flyback converter according to embodiments of the present disclosure, the driving current regulation circuit generates a current regulation trigger signal at active state correspondingly according to the operating state of the flyback converter, the switch control driving unit regulates the driving signal of the first switch transistor according to the current regulation trigger signal at active state, and when the current regulation trigger signal is at inactive state, the switch control driving unit drives the first switch transistor to be turned on at a first switching rate; when the current regulation trigger signal is at active state, the switch control driving unit drives the first switch transistor to be turned on at a second switching rate, wherein the second switching rate is lower than the first switching rate. According to the present disclosure, the switching rate of the first switch transistor is controlled to be the second switching rate when it is detected that the flyback converter is operating in discontinuous conduction mode or the drain-source voltage across the first switch transistor is high, so that a voltage across the rectifier switch transistor on the secondary side of the flyback converter does not undergo a large jump, the system EMI is good, and an overall conduction loss of the system is low.

### BRIEF DESCRIPTION OF THE DRAWINGS

FIG. 1 shows a circuit block diagram of an asymmetric half-bridge topology of a conventional flyback converter;

FIG. 2 shows a circuit block diagram of another asymmetric half-bridge topology of a conventional flyback converter;

FIG. 3 is a circuit block diagram of a switch control circuit of a flyback converter according to an embodiment of the present disclosure;

FIG. 4 is a circuit block diagram of a first embodiment of the driving current regulation circuit as shown in FIG. 3;

FIG. 5 is an operating waveform diagram according to FIG. 3;

FIG. 6 is a circuit block diagram of a second embodiment of the driving current regulation circuit as shown in FIG. 3;

FIG. 7 is a circuit block diagram of a third embodiment of the driving current regulation circuit as shown in FIG. 3;

FIG. 8 is a circuit diagram of a first embodiment of a switch control driving unit according to the present disclosure;

FIG. 9 is a circuit diagram of a second embodiment of a switch control driving unit according to the present disclosure.

### DETAILED DESCRIPTION OF EMBODIMENTS OF THE DISCLOSURE

The following preferred embodiments of the present disclosure are described in detail in conjunction with attached drawings, but the disclosure is not limited to these embodiments. The present disclosure covers any method and scheme that may be substitutions, modifications, equivalents within the spirit and scope of the present disclosure.

In order to enable the public to have a thorough understanding of the present disclosure, specific details are described in detail in the following preferred embodiment of the present disclosure, even in a case that the present disclosure can be fully understood by those skilled in the art without the description of these details.

The present disclosure is described more specifically by way of example hereinafter with reference to the accompanying drawings. It should be noted that the accompanying drawings are simplified and not drawn to precise scale, and are only used to facilitate and clearly assist the purpose of illustrating the embodiments of the present disclosure.

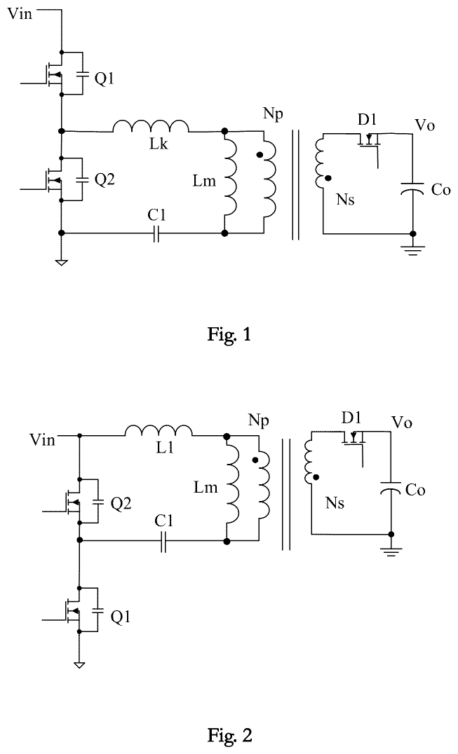

FIG. 1 shows a circuit block diagram of an asymmetric half-bridge topology of a conventional flyback converter. For case of illustration, only a main power stage circuit of the flyback converter is shown in FIG. 1, and a switch control module that provides a switch control signal to a switch transistor is not shown.

In the asymmetric half-bridge topology as shown in FIG. 1, the flyback converter 100 includes: a transformer T having a primary side winding Np and a secondary side winding Ns; switch transistors Q1 and Q2 which are located on the primary side of the flyback converter; a resonant inductor Lk and a resonant capacitor Cr; a rectifier transistor D1 (generally a synchronous switch transistor) and an output capacitor Co, which are located on the secondary side of the transformer T, wherein the rectifier transistor D1 and the secondary side winding Ns of the transformer T are connected in series between a voltage output terminal and a reference ground of the secondary side.

On the primary side of the transformer T, the first switch transistor Q1 and the second switch transistor Q2 are sequentially connected in series between a voltage input terminal and a reference ground of the primary side. In an optional embodiment, both the first switch transistor Q1 and the second switch transistor Q2 are NMOS field effect transistors. The primary side winding Np of the transformer T, the resonant inductor Lk, and the resonant capacitor Cr are connected in series between a source electrode and a drain electrode of the second switch transistor Q2, and together form a resonant circuit when the second switch transistor Q2 is in turn-on state. An equivalent inductor of the primary side winding of the transformer T in the resonant circuit serves as an excitation inductor Lm. Preferably, in power supply applications with low power, a leakage inductor of the transformer T can be used instead of the resonant inductor Lk.

FIG. 2 shows a circuit block diagram of another asymmetric half-bridge topology of a conventional flyback converter. For the sake of clarity, only a main circuit of the flyback converter is shown in FIG. 2, and a switch control module for providing a switch control signal to the switch transistor is not shown.

In the asymmetric half-bridge topology as shown in FIG. 2, the flyback converter 200 includes a transformer T having a primary side winding Np and a secondary side winding Ns, switch transistors Q1 and Q2 which are both located on the primary side of the flyback converter, a resonant inductor Lk and a resonant capacitor Cr, a rectifier transistor D1 which is located on the secondary side of the transformer T, and an output capacitor Co.

On the primary side of the transformer T, the second switch transistor Q2 and the first switch transistor Q1 are sequentially connected in series between a voltage input terminal and a reference ground of the primary side. In an optional embodiment, both the first switch transistor Q1 and the second switch transistor Q2 are NMOS field effect transistors. The primary side winding Np of the transformer T, the resonant inductor Lk, and the resonant capacitor Cr are connected in series between a source electrode and a drain electrode of the second switch transistor Q2, and together form a resonant circuit when the second switch transistor Q2 is in turn-on state. An equivalent inductor of the primary side winding of the transformer T in the resonant circuit serves as an excitation inductor Lm. Preferably, in power supply applications with low power, a leakage inductor of the transformer T can be used instead of the resonant inductor Lk.

On the secondary side of the transformer T, the rectifier transistor D1 and the secondary side winding Ns of the transformer T are connected in series between a voltage output terminal and a reference ground of the secondary side. An anode of the rectifier transistor D1 is connected to a heteronymous end of the secondary side winding Ns to rectify an induced voltage which is inverted with an excitation voltage of the transformer T, so as to provide a DC output voltage Vo. The output capacitor Co is connected between the voltage output terminal and the reference ground of the secondary side, to perform filtering on the DC output voltage Vo, so as to obtain a smooth voltage waveform.

Preferably, the asymmetric half-bridge flyback converter further includes a sampling resistor Rcs, which is connected between the source electrode of the second switch transistor Q2 and the reference ground, and configured to obtain a current flowing through the first switch transistor Q1 when the first switch transistor Q1 is turned on and the second switch transistor Q2 is turned off.

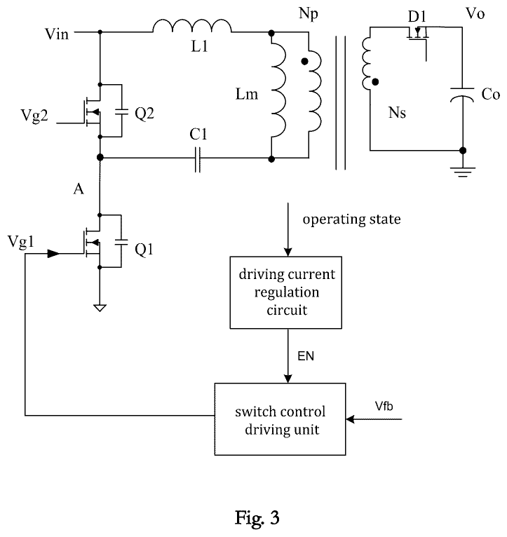

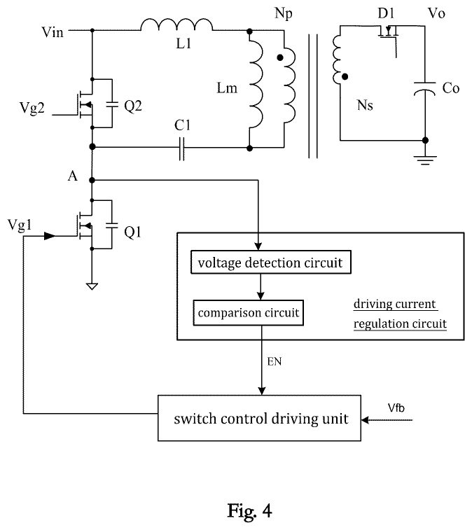

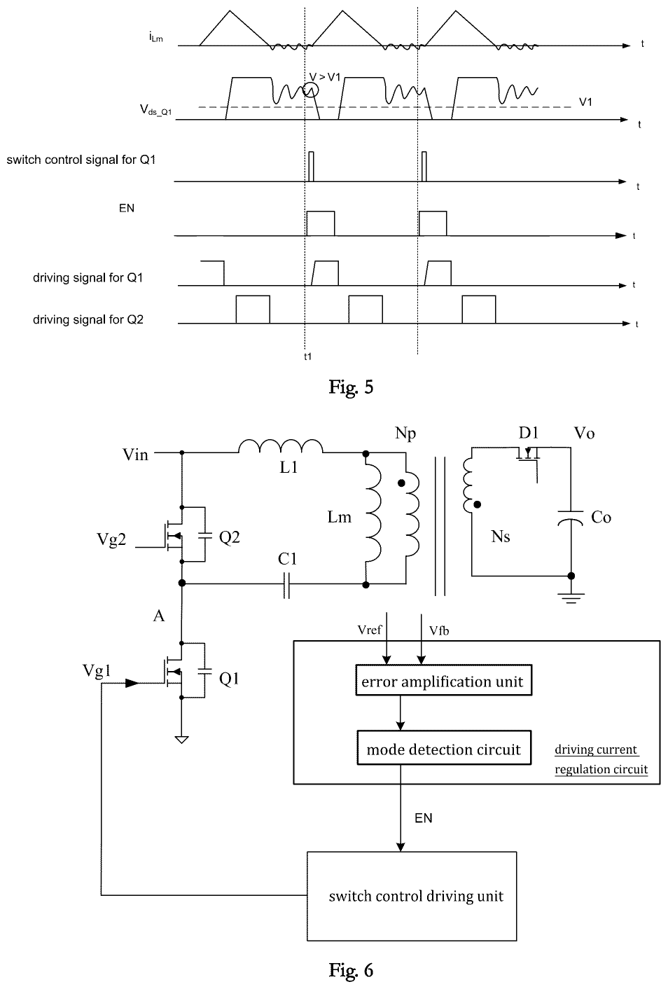

FIG. 3 is a circuit block diagram of a switch control circuit of a flyback converter according to the present disclosure, FIG. 4 is a circuit block diagram of a first embodiment of a driving current regulation circuit as shown in FIG. 3, and FIG. 5 is an operating waveform diagram according to FIG. 3. In the embodiment as shown in FIG. 3, the switch control circuit according to the present embodiment includes a switch control driving unit and a driving current regulation circuit, wherein the switch control driving unit is configured to generate a first switch driving signal Vg1 and a second switch driving signal Vg2 to drive the first switch transistor Q1 and the second switch transistor Q2, respectively, according to an output feedback signal (such as Vfb) of the flyback converter; the driving current regulation circuit is configured to generate a current regulation trigger signal EN according to an operating state of the flyback converter, the current regulation trigger signal EN is transmitted to the switch control driving unit, and when the current regulation trigger signal EN is at inactive state, such as a low voltage level state, the switch control driving unit is configured to drive the first switch transistor to be turned on at a first switching rate; when the current regulation trigger signal EN is at active state, such as a high voltage level state, the switch control driving unit is configured to drive the first switch transistor to be turned on at a second switching rate, wherein the second switching rate is lower than the first switching rate. The first switching rate generally refers to a normal rate for turning on a switch transistor. Due to different materials and manufacturing processes of the switch transistor, the normal rate for turning on the switch transistor may be varied, but under normal circumstances, the first switching rate is generally set to meet circuit requirements.

Referring to FIG. 4, the driving current regulation circuit includes a voltage detection circuit and a comparison circuit. The voltage detection circuit is configured to detect a drain-source voltage Vds across the first switch transistor Q1 to obtain a voltage detection signal. The comparison circuit is configured to compare the voltage detection signal and a first threshold voltage V1, and generate the current regulation trigger signal EN at active state if the voltage detection signal is greater than the first threshold voltage. Referring to FIG. 5, at time t1, the switch control signal of the first switch transistor indicates that the first switch transistor Q1 is about to be turned on, at this time, the drain-source voltage Vds across the first switch transistor Q1 is detected, and when the drain-source voltage Vds across the first switch transistor Q1 is greater than the first threshold voltage V1, the current regulation trigger signal EN jumps to high voltage level. At this time, the driving signal Vg1 of the first switch transistor Q1 will be reduced, causing the switching rate of the first switch transistor to be slowed down.

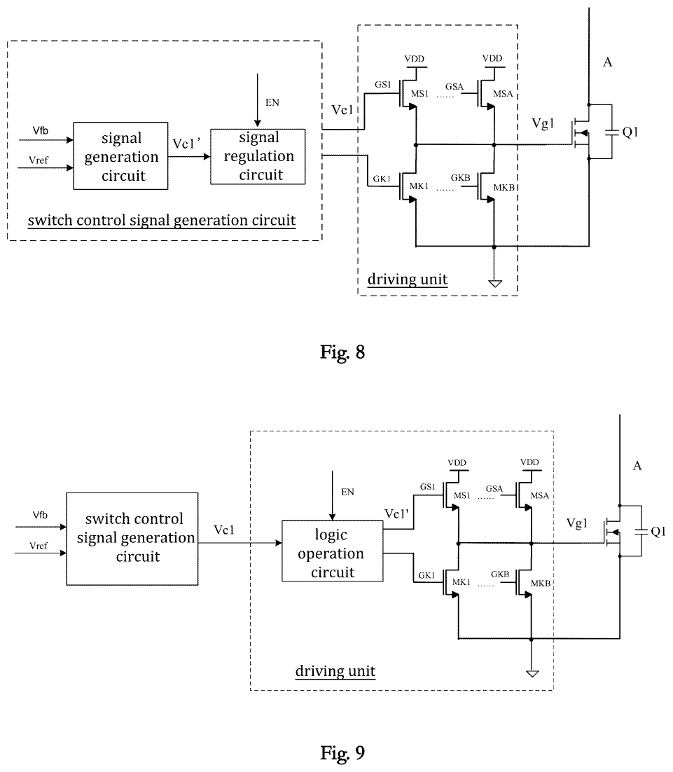

Preferably, when the current regulation trigger signal EN is at active state, the switch control driving unit controls a pull-up driving current of the first switch transistor Q1 to be reduced, so as to drive the first switch transistor Q1 to be turned on at a second switching rate. FIG. 8 is a circuit diagram of a first embodiment of a switch control driving unit according to the present disclosure. The switch control driving unit includes a switch control signal generation circuit and a driving unit. The switch control signal generation circuit is for generating a first switch control signal and a second switch control signal according to the output feedback signal Vfb and an output reference signal Vref, and the driving unit is for generating a first switch driving signal and a second switch driving signal according to the first switch control signal and the second switch control signal, respectively. In FIG. 8, only the switch control driving unit for the first switch transistor Q1 is shown. The switch control signal generation unit can include existing circuit structures such as an error amplification circuit, a clock circuit, and an inductance current comparison circuit, etc., and is configured to generate the first switch control signal Vc1′ according to the output feedback signal Vfb and the output reference signal Vref. The driving unit may include a plurality of upper driving switches connected in parallel and a plurality of lower driving switches connected in parallel, so as to control a pull-up driving current and a pull-down driving current, wherein the pull-up driving current controls a turning on rate of the first switch transistor, and the pull-down driving current controls a turning off rate of the first switch transistor. In this embodiment, the pull-up driving current is regulated. When the current regulation trigger signal EN is at active state, the signal regulation circuit is configured to regulate a voltage value of the first switch control signal Vc1′ to obtain an regulated first switch control signal Vc1, and the regulated first switch control signal Vc1 controls the number of at least one upper driving switch that is to be turned on, so as to regulate the pull-up driving current of the first switch transistor, by, for example, controlling the pull-up driving current to decrease.

In order to better control a variation of the turning on rate of the first switch transistor, which may avoid frequent switching between the first switching rate and the second switching rate, in the present embodiment, when the drain-source voltage across the first switch transistor of the flyback converter is reduced to be lower than a second threshold voltage V2, the first switch transistor is controlled to be turned on at the first switching rate, and when the drain-source voltage across the first switch transistor of the flyback converter is increased to be greater than the first threshold voltage V1, the first switch transistor is controlled to be turned on at the second switching rate, wherein the first threshold voltage is greater than the second threshold voltage.

Preferably, when the first switch transistor is turned on at the second switching rate, a variation rate of the drain-source voltage of the first switch transistor can be slowed down to a preset range. Depending on a type of the first switch transistor, the preset range is set as follows: if the first switch transistor is a silicon-based transistor, the preset range is set to 2V/ns to 10V/ns; if the first switch transistor is a GaN-based transistor, the preset range is set to 5V/ns to 100V/ns. According to operating characteristics of a transistor, whether the switching rate of the transistor is fast or slow corresponds to whether a variation rate of a voltage across the transistor is fast or slow. Therefore, when the switching rate of the first switch transistor is the second switching rate, the variation rate of the voltage across the first switch transistor is also lower than the variation rate of the voltage across the first switch transistor when the switching rate of the first switch transistor is the first switching rate. In this way, due to the decrease of the variation rate of the voltage across the first switch transistor, when the first switch transistor is turned on, voltage oscillation across that rectifier transistor on the secondary side can be reduced, a peak voltage can be reduced, thus greatly reducing the switching stress of the rectifier transistor and reducing the system EMI. It should be noted that the preset range according to the present disclosure is just a preferred example, and there will be differences between different switch transistors.

FIG. 6, is a circuit block diagram of a second embodiment of the driving current regulation circuit as shown in FIG. 3. In this embodiment, the driving current regulation circuit includes an error amplification unit and a mode detection circuit. The error amplification unit is configured to detect the operating mode of the flyback converter according to the output feedback signal Vfb and the output reference signal Vref of the flyback converter. When the mode detection circuit detects that the flyback converter is operating in discontinuous conduction mode, a current regulation trigger signal at active state is generated by the mode detection circuit. The error amplification unit can multiplex the error amplification circuit in the switch control driving unit. According to an error amplification result, the operating mode of the flyback converter can be determined. For example, when the error amplification result is relatively large, it represents that the operating mode of the flyback converter is discontinuous conduction mode. If the flyback converter is operating in discontinuous conduction mode, a variation rate of the voltage across the first switch transistor is reduced by reducing the turning on rate of the first switch transistor, so that during a turning on process of the first switch transistor, a jitter of a voltage rise across the synchronous rectifier switch transistor on the secondary side can be small, no large peak voltage may occur, and the switching stress of the synchronous rectifier transistor can be reduced.

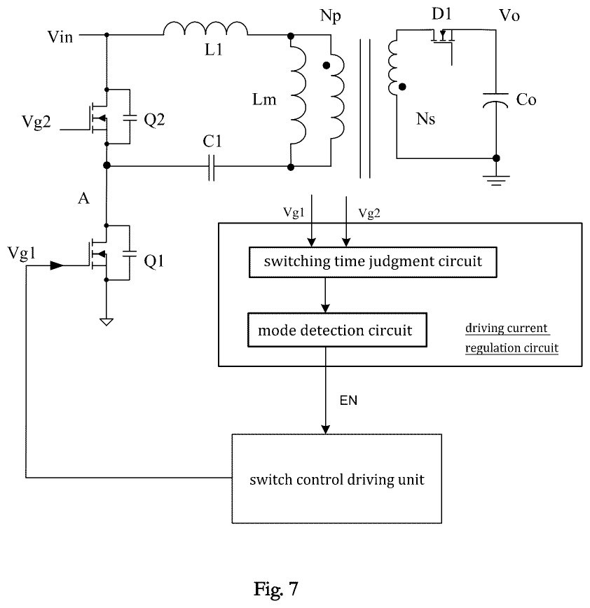

FIG. 7 is a circuit block diagram of a third embodiment of the driving current regulation circuit as shown in FIG. 3. The driving current regulation circuit includes a switching time judgment circuit and a mode detection circuit. The switching time judgment circuit is configured to detect the operating mode of the flyback converter according to the switching times of the first switch transistor and the second switch transistor. When a time interval, which starts from a time for turning off the second switch transistor to a time for turning on the first switch transistor, reaches a first time threshold, the flyback converter is detected, by the mode detection circuit, to be operating in discontinuous conduction mode. After the second switch transistor is turned off, a current flowing through the inductor of the flyback converter drops to near zero. If the time interval, which starts from a time for turning off the second switch transistor to a time for turning on the first switch transistor, is long, it means that the flyback converter enters discontinuous conduction mode, and the current flowing through the inductor may oscillate near zero. The time interval between the switching times of the first and second switch transistors can be obtained according to the driving signals of the first and second switch transistors. Similarly, in this embodiment, by reducing the turning on rate of the first switch transistor, the variation rate of the voltage across the first switch transistor is reduced, so that in a turning on process of the first switch transistor, the jitter of the voltage rise across the synchronous rectifier switch transistor on the secondary side can be small, no large peak voltage may occur, and the switching stress of the synchronous rectifier transistor can be reduced.

FIG. 9 is a circuit diagram of a second embodiment of the switch control driving unit according to the present disclosure. In this embodiment, the current regulation trigger signal is transmitted to the driving unit, and the driving unit is configured to obtain a logic operation signal Vc1′ according to a logic operation performed on the current regulation trigger signal EN and the switch control signal Vc1 transmitted from the switch control signal generation circuit, and control the number of at least one upper driving switch that is controlled to be turned on according to the logic operation signal, so as to regulate the pull-up driving current, where the logic operation can be implemented by an operator for performing addition operation and/or subtraction operation. The driving unit may further include a plurality of parallel driving branches each of which is formed by a current source and a resistor, the switch control driving unit is configured to control the pull-up driving current of the first switch transistor by regulating a current flowing through one or more of the plurality of parallel driving branches according to the current regulation trigger signal EN at active state. The regulation can be performed according to different situations of the circuit, only needs to control the upper current to have a magnitude as needed.

The present disclosure also provides a flyback converter including a transformer, a first switch transistor, a second switch transistor, a first capacitor, a first inductor and the switch control circuit which controls the first switch transistor and the second switch transistor to be turned on and off, wherein a resonant circuit is formed by the first capacitor and the first inductor when the second switch transistor is in turn-on state; the flyback converter further includes a rectifier switch transistor, the first switch transistor and the second switch transistor are located on the primary side of the transformer, and the rectifier switch transistor is located on the secondary side of the transformer.

According to the flyback converters and corresponding control solutions in this disclosure, by reducing the turning on rate of the first switch transistor, the variation rate of the voltage across the first switch transistor can be reduced, and during a turning on process of the first switch transistor, the jitter of the voltage rise across the synchronous rectifier switch transistor on the secondary side can be small, no large peak voltage may occur, and the switching stress of the synchronous rectifier transistor can be reduced. At the same time, in discontinuous conduction mode, the current flowing through the inductor drops to zero, and the drain-source voltage across the first switch transistor is low, thus the turning-on loss of the first switch transistor is also low.

The flyback converters according to the above embodiments are illustrated with asymmetric flyback converters as examples. However, it can be understood that the present disclosure is not limited thereto. Based on similar operating principles, the solutions of the above embodiments can also be applied to flyback converters with other structures, such as a flyback converter with an active clamped topology.

Additionally, the embodiments and the attached drawings are merely given for describing one example of implementing the present disclosure, but not to limit the specific structure of the present disclosure's implementation. Various changes or modifications can be made to these embodiments without departing from the principles and essence of the present disclosure. All of such changes and modifications fall within the scope of protection of the present disclosure.

Although the above embodiments are described and explained separately, some technical aspects are commonly shared. It can be understood by those skilled in the art that some technical aspects of the embodiments can be replaced or combined together. Even in a case that some aspects are not explicitly depicted in one embodiment, reference may be made to other embodiments.

The above-mentioned embodiments do not limit the scope of protection of the technical solution. Any modifications, equivalent substitutions, and improvements made within the spirit and principles of the embodiments mentioned above shall be included within the scope of protection of the present disclosure.

1. A switch control circuit of a flyback converter comprising a transformer, a first switch transistor, a second switch transistor, a first capacitor and a first inductor, wherein a resonant circuit is formed by the first capacitor and the first inductor when the second switch transistor is in turn-on state, and the switch control circuit comprises:
a switch control driving unit, configured to generate a first switch driving signal and a second switch driving signal according to an output feedback signal of the flyback converter, to drive the first switch transistor and the second switch transistor, respectively,
a driving current regulation circuit, configured to generate a current regulation trigger signal according to an operating state of the flyback converter, the current regulation trigger signal being transmitted to the switch control driving unit,
wherein when the current regulation trigger signal is at inactive state, the switch control driving unit drives the first switch transistor to be turned on at a first switching rate;
when the current regulation trigger signal is at active state, the switch control driving unit drives the first switch transistor to be turned on at a second switching rate, wherein the second switching rate is lower than the first switching rate.

2. The switch control circuit according to claim 1, wherein when the first switch transistor is turned on at the second switching rate, a variation rate of a drain-source voltage across the first switch transistor is slowed down to a preset range.

3. The switch control circuit according to claim 2, wherein, depending on a type of the first switch transistor, the preset range is set as follows:
when the first switch transistor is a silicon-based transistor, the preset range is set to 2V/ns to 20V/ns;
when the first switch transistor is a GaN-based transistor, the preset range is set to 5V/ns to 200V/ns.

4. The switch control circuit according to claim 1, wherein when the current regulation trigger signal is at active state, the switch control driving unit controls a pull-up driving current of the first switch transistor to decrease, so as to drive the first switch transistor to be turned on at the second switching rate.

5. The switch control circuit according to claim 1, wherein the driving current regulation circuit comprises a voltage detection circuit and a comparison circuit,
before the first switch transistor is turned on, the voltage detection circuit is configured to obtain a voltage detection signal by detecting a drain-source voltage across the first switch transistor,
the comparison circuit is configured to compare the voltage detection signal and a first threshold voltage, and generate the current regulation trigger signal at active state if the voltage detection signal is greater than the first threshold voltage.

6. The switch control circuit according to claim 1, wherein the driving current regulation circuit comprises a mode detection circuit,
configured to generate the current regulation trigger signal at active state when the mode detection circuit detects that the flyback converter is operating in discontinuous conduction mode.

7. The switch control circuit according to claim 6, wherein the driving current regulation circuit is configured to detect an operating mode of the flyback converter according to switching times of the first switch transistor and the second switch transistor,
the mode detection circuit detects that the flyback converter is operating in discontinuous conduction mode when a time interval, which starts from a time for turning off the second switch transistor to a time for turning on the first switch transistor, reaches a first time threshold.

8. The switch control circuit according to claim 6, wherein the driving current regulation circuit detects an operating mode of the flyback converter according to an output reference signal and the output feedback signal of the flyback converter.

9. The switch control circuit according to claim 4, wherein the switch control driving unit comprises a switch control signal generation circuit and a driving unit,
the switch control signal generation circuit is configured to generate a first switch control signal and a second switch control signal according to the output feedback signal and an output reference signal,
the driving unit is configured to generate the first switch driving signal and the second switch driving signal according to the first switch control signal and the second switch control signal, respectively.

10. The switch control circuit according to claim 9, wherein the driving unit comprises a plurality of driving switches that are connected in parallel,
the switch control driving unit is configured to adjust a number of one or more of the plurality of driving switches which is controlled to be turned on, according to the current regulation trigger signal at active state, so as to regulate a pull-up driving current of the first switch transistor.

11. The switch control circuit according to claim 9, wherein the driving unit comprises a plurality of parallel driving branches, each of which is formed by a current source and a resistor,
the switch control driving unit is configured to regulate a current through one or more of the plurality of parallel driving branches according to the current regulation trigger signal at active state, so as to control a pull-up driving current of the first switch transistor.

12. The switch control circuit according to claim 10, wherein
the switch control signal generation circuit comprises a signal generation circuit and a signal regulation circuit, the signal generation circuit is configured to generate the first switch control signal and the second switch control signal according to the output feedback signal and the output reference signal;
the signal regulation circuit is configured to perform regulation on the first switch control signal and the second switch control signal according to the current regulation trigger signal, to transmit the first switch control signal and the second switch control signal, which are obtained after the regulation, to the driving unit as output signals.

13. The switch control circuit according to claim 10, wherein the driving unit comprises a logic operation circuit and a driving circuit,
the logic operation circuit is configured to generate a first logic operation signal and a second logic operation signal according to the current regulation trigger signal, the first switch control signal and the second switch control signal,
the driving circuit is configured to control a pull-up driving current of the first switch transistor and a pull-up driving current of the second switch transistor according to the first logic operation signal and the second logic operation signal.

14. A switch control method of a flyback converter comprising a transformer, a first switch transistor, a second switch transistor, a first capacitor and a first inductor, wherein a resonant circuit is formed by the first capacitor and the first inductor when the second switch transistor is in turn-on state, and the switch control method comprises:
generating a current regulation trigger signal at active state correspondingly according to an operating state of the flyback converter,
generating a first switch driving signal and a second switch driving signal according to an output feedback signal of the flyback converter to drive the first switch transistor and the second switch transistor, respectively,
when the current regulation trigger signal is at inactive state, controlling the first switch transistor to be turned on at a first switching rate;
when the current regulation trigger signal is at active state, controlling the first switching transistor to be turned on at a second switching rate, wherein the second switching rate is lower than the first switching rate.

15. The switch control method according to claim 12, wherein when the current regulation trigger signal is at active state, a pull-up driving current of the first switch transistor is regulated to decrease, so as to control the first switch transistor to be turned on at the second switching rate,
wherein when the first switch transistor is turned on at the second switching rate, a variation rate of a drain-source voltage across the first switch transistor is slowed down to a preset range.

16. The switch control method according to claim 15, wherein the preset range is set as follows:
when the first switch transistor is a silicon-based transistor, the preset range is set to 2V/ns to 20V/ns;
when the first switch transistor is a GaN-based transistor, the preset range is set to 5V/ns to 200V/ns.

17. The switch control method according to claim 14, wherein generating the current regulation trigger signal at active state correspondingly according to the operating state of the flyback converter comprises:
when the flyback converter is operating in discontinuous conduction mode, generating the current regulation trigger signal at active state correspondingly.

18. The switch control method according to claim 14, wherein generating the current regulation trigger signal at active state correspondingly according to the operating state of the flyback converter comprises:
before the first switch transistor is turned on, when a drain-source voltage across the first switch transistor of the flyback converter is greater than a first threshold voltage, generating the current regulation trigger signal at active state correspondingly.

19. The switch control method according to claim 18, wherein when the drain-source voltage across the first switch transistor of the flyback converter decreases to be lower than a second threshold voltage, the first switch transistor is controlled to be turned on at the first switching rate; and when the drain-source voltage across the first switch transistor of the flyback converter rises to be greater than the first threshold voltage, the first switch transistor is controlled to be turned on at the second switching rate, wherein the first threshold voltage is greater than the second threshold voltage.

20. A flyback converter, comprising a transformer, a first switch transistor, a second switch transistor, a first capacitor, a first inductor, and a switch control circuit according to claim 1, wherein a resonant circuit is formed by the first capacitor and the first inductor when the second switch transistor is in turn-on state,
wherein the switch control circuit is configured to control the first switch transistor and the second switch transistor to be turned on and off;
the flyback converter further comprises a rectifier switch transistor, which is located on a secondary side of the transformer, and the first switch transistor and the second switch transistor are located on a primary side of the transformer.
